(19) United States
(12) Patent Application Publication
(10) Pub. No.: US 2007/0132195 A1
(43) Pub. Date: Jun. 14, 2007

(54) Bearing seal

(76) Inventor: Kazuo Ishii, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 11/655,994

(22) Filed: Jan. 22, 2007

Related U.S. Application Data
(63) Continuation of application No. 11/059,690, filed on Feb. 17, 2005, now abandoned.

(30) Foreign Application Priority Data
Feb. 20, 2004 (JP) 2004-045311

(51) Int. Cl. F16J 15/32

(52) U.S. Cl. 277/562; 277/551

(57) ABSTRACT

A bearing seal that is designed so that it can be mounted between one element and the other element of a bearing rotating relative to each other, thereby sealing the bearing. The bearing seal includes a seal ring and a seal body. The seal ring and seal body being adapted to be fitted on and secured to the one element and other element of the bearing rotating relative to each other, respectively. The seal ring includes a first cylindrical portion extending in the axial direction of the bearing and adapted to be fitted on and secured to the peripheral wall of the one element rotating relative to the other element of the bearing, a flange portion extending from the first cylindrical portion toward the radial direction, and a second cylindrical portion extending from the forward end side of the flange portion toward the axial direction of the bearing. The seal body includes a reinforcing ring having a radial one end side adapted to be fitted on and secured to the peripheral wall of the other element rotating relative to the one element of the bearing and having the other end side extending toward the seal ring and an elastic element reinforced by the reinforcing ring. Upon the seal ring and seal body being mounted in the bearing, the elastic element includes a first lip portion, s second lip portion and a third lip portion. The first lip portion is extending from the reinforcing ring toward the radial other end side and adapted to make sliding contact with the peripheral wall of the first cylindrical portion of the seal ring. The second lip portion, located axially of the bearing and inwardly of the first lip portion, is extending from the reinforcing ring toward the radial other end side and adapted to make sliding contact with the peripheral wall of the first cylindrical portion of the seal ring. The third lip portion, located axially of the bearing and inwardly of the second lip portion, is extending from the reinforcing ring toward the radial direction and adapted to make sliding contact with the peripheral wall of the second cylindrical portion of the seal ring.

### BACKGROUND OF THE INVENTION

This application is a continuation of U.S. application Ser. No. 11/059,690, filed Feb. 17, 2005, now abandoned.

### FIELD OF THE INVENTION

The present invention relates to a bearing seal that is designed so that it can be mounted between one element and the other element of a bearing that rotate relative to each other, thereby sealing the bearing both internally and externally. More particularly, the present invention relates to such bearing seal that is suitable for use with a water pump that is used in conjunction with the water-cooled engine on an automotive vehicle.

### PRIOR ART

In the bearing that includes two elements rotating relative to each other, such as an inner race and an outer race, there is a bearing seal that may be mounted between those two elements, e.g., the inner race and outer race of the bearing, thereby sealing the bearing both internally and externally, wherein it is well known that such bearing seal includes a metallic reinforcing ring and an elastic element, such as rubber, that is reinforced by the reinforcing ring.

In the water pump that is used with a water-cooled engine and the like on an automotive vehicle, such bearing seal as the one that includes the metallic reinforcing ring and the elastic element reinforced by the reinforcing ring may also be used.

One example of the water pump is shown in FIG. 10, in which it is known that such water pump includes a pump shaft 53 having an impeller 51 connected to one end thereof and a pulley 52 connected to the other end thereof, and may be operated so that it can circulate cooling water by rotating the pulley 52 that causes the impeller 51 to rotate. In the example shown in FIG. 10, the water pump generally has a water pump bearing that may be inserted under the applied pressure into a pump housing 50 that is being mounted on the automotive vehicle engine. In the water pump bearing, the pump shaft 53 having the impeller 51 connected to one end thereof and the pulley 52 connected to the other end may be mounted rollingly to the outer race of the bearing by way of the rolling element 55.

Between the outer race 54 and pump shaft 53, there is a mechanical seal 57 that is designed to seal the area between the space 58 existing between the pump housing 50 and pump shaft 53 and the impeller 51.

On each of the opposite ends of the outer race 54 is a bearing seal that is designed to seal the interior of the bearing. One of those bearing seals, that is, the bearing seal 56 on one end of the outer race 54 on which the impeller 51 is provided generally includes a metallic reinforcing ring and an elastic element reinforced by the reinforcing ring.

The bearing seal that includes the metallic reinforcing ring and the elastic element reinforced by the reinforcing ring and may be mounted between the two elements of the bearing rotating relative to each other, thereby sealing the bearing both internally and externally is required to provide the sealing capabilities with the high reliability even when it is used under the hardest operating environment for an extended period of the time. The reason is that if the bearing seal should fail and its sealing capability should thus be affected, this would lead to the failure of the bearing on which the bearing seal is mounted, resulting in the failure of the device on which such bearing is mounted. Finally, the lifetime of the device would become shorter.

For example, the sealing capability may be affected when the bearing seal 56 mounted on the side of the impeller is heated or cooled each time the engine is stopped or restarted, causing the air inside the bearing to expand or contract.

For the water pump described earlier, on the other hand, if the sealing capability of the mechanical seal 57 degrades over the time, the cooling water may flow from the side of the impeller 51 into the space 58 between the pump housing 50 and pump shaft 53.

The cooling water that has flowed into the space 58 between the pump housing 50 and pump shaft 53 or the steam that has been produced as the cooling water has been heated may go through the location of the bearing seal 56 into the bearing. If this actually occurs, it may cause the grease filled in the bearing to degrade, producing rust that may cause the water pump to fail. Thus, the lifetime of the water pump may become shorter.

It may also be appreciated from the preceding description that the grease that is filled inside the bearing might pass through the location of the bearing seal if its sealing capability should accidentally be lost, flowing out from inside the bearing. If this actually occurs, the friction between the rolling element 55 and pump shaft 53 will become greater, causing the water pump bearing to be damaged. This will result in the lifetime of the water pump becoming shorter.

In connection with the bearing seal that is designed to be mounted between one element and the other element of the bearing rotating relative to each other for sealing the bearing, more specifically, the bearing seal that is designed for use with the water pump employed in the water-cooled engine on the automotive vehicle, the inventor of the present invention has addressed the problems associated with the prior art described above, and has proposed various bearing seals as disclosed in Japanese patent application now published under No. 2003-155998.

### SUMMARY OF THE INVENTION

Following the various water pump bearing seals proposed as disclosed in the above Japanese patent application No. 2003-155998, the inventor of the present application has made further studies, and has successfully developed a bearing seal designed to be mounted between the two elements of the bearing rotating relative to each other for sealing the bearing, wherein the bearing seal can provide the sealing capabilities with the high reliability even when it is used under the hardest operating environment for an extended period of the time, and can effectively accommodate any misalignment that may occur when the bearing is mounted, or any misalignment in the axial direction that may be caused by any errors in mounting the bearing.

In order to solve the aforementioned problems, the present invention proposes to provide a bearing seal that includes a seal ring and a seal body that may be fitted on and secured to one element and the other element of the bearing rotating relative to each other, respectively, wherein the bearing seal has the structural features and forms that may be characterized as described below by referring to the accompanying drawings.

The seal body 4 includes a reinforcing ring 2 having one end extending radially and adapted to be fitted on and secured to the peripheral wall of the other element of the bearing rotating relative to the one element, and an elastic element 3 reinforced by the reinforcing ring 2.

The seal ring 8 includes a first cylindrical portion 5 extending in the axial direction of the bearing perpendicular to the radial direction of the seal body 4 and adapted to be fitted on and secured to the peripheral wall of the one element of the bearing rotating relative to the other element, a flange portion 6 extending from the first cylindrical portion 5 toward the radial direction, and a second cylindrical portion 7 extending from the forward end of the flange portion 6 toward the axial direction of the bearing.

The embodiment in which the first cylindrical portion 5 of the seal ring 8 is adapted to be fitted on and secured to the peripheral wall of the one element of the bearing rotating relative to the other element may have two different forms, one being the form in which the first cylindrical portion 5 may be fitted on and secured to the peripheral wall in the direct manner as shown in FIGS. 1 to 6, and the other being the form in which the first cylindrical portion 5 may be fitted on and secured to the peripheral wall indirectly, that is, by way of a slinger 23 including a cylindrical portion 21 extending in the axial direction of the bearing and a flange portion 20 extending from the end of the cylindrical portion 21 located on the axial outer side thereof toward the radial direction as shown in FIGS. 7 to 9.

In the form in which the first cylindrical portion 5 may be fitted on and secured to the peripheral wall indirectly, that is, by way of the slinger 23, one peripheral surface of the cylindrical portion 21 of the slinger 23 may be fitted on and secured to the first cylindrical portion 5 of the seal ring 8, with the other peripheral surface being fitted on and secured to the peripheral wall of the one element of the bearing rotating relative to the other element.

The elastic element 3 that forms part of the seal body 4 has the structural features that will be described below.

The elastic element 3 includes a first lip portion 9, a second lip portion 10 and a third lip portion 11a (FIGS. 1 to 3 and FIGS. 7 to 9) or 11b (FIGS. 4 to 6), each of which has the respective structural features and forms that will be described below. Because of the structural features and forms, those lip portions may provide the respective functions that will also be described below, when the seal ring 8 and seal body 4 are mounted on the bearing.

Specifically, the first lip portion 9 is provided so that it extends from the reinforcing ring 2 of the seal body 4 toward the other end opposite the radial one end, and may be made to make sliding contact with the peripheral wall 53a of one element of the bearing rotating relative to the other element or the peripheral wall 5a of the first cylindrical portion 5 of the seal ring 8. For example, the first lip portion 9 extends from the reinforcing ring 2 of the seal body 4 toward the other end opposite the radial one end, that is, toward the axial outer side (the right side in FIGS. 1 to 6) and then extends obliquely toward the radial inner side (the lower side in FIGS. 1 to 6), and is adapted to make sliding contact with the peripheral wall 53a of one element of the bearing rotating relative to the other element as shown in FIGS. 2, 3, 5 and 6, or the peripheral wall 5a of the first cylindrical portion 5 of the seal ring 8 as shown in FIGS. 1 and 4.

In the form as shown in FIGS. 7 to 9 in which the first cylindrical portion 5 of the seal ring 8 may be fitted on and secured to the peripheral wall of the one element of the bearing rotating relative to the other element indirectly, that is, by way of the slinger 23, the first lip portion 9 may be brought into sliding contact with the one peripheral surface of the cylindrical portion 21 of the slinger 23 as shown in FIGS. 8 and 9, or may be brought into sliding contact with the peripheral wall 5a of the first cylindrical portion 5 of the seal ring 8 as shown in FIG. 7.

The second lip portion 10 is located on the axial inner side of the bearing from the first lip portion 9 as shown in FIGS. 1 to 9, extends from the reinforcing ring 2 of the seal body 4 toward the other end opposite the radial one end, and is adapted to make sliding contact with the peripheral wall 53a of one element of the bearing rotating relative to the other element or the peripheral wall 5a of the first cylindrical portion 5 of the seal ring 8. For example, the second lip portion 10 extends from the reinforcing ring 2 of the seal body 4 toward the other end opposite the radial one end, that is, extends toward the axial outer side (the right side in FIGS. 1 to 9) and then extends obliquely toward the radial inner side (the lower side in FIGS. 1 to 9), and is adapted to make sliding contact with the peripheral wall 53a of one element of the bearing rotating relative to the other element as shown in FIGS. 3 and 6, or the peripheral wall 5a of the first cylindrical portion 5 of the seal ring 8 as shown in FIGS. 1, 2, 4 and 5.

In the form as shown in FIGS. 7 to 9 in which the first cylindrical portion 5 of the seal ring 8 may be fitted on and secured to the peripheral wall of the one element of the bearing rotating relative to the other element indirectly, that is, by way of the slinger 23, the second lip portion 10 may be brought into sliding contact with the one peripheral surface of the cylindrical portion 21 of the slinger 23 as shown in FIG. 9, or may be brought into sliding contact with the peripheral wall 5a of the first cylindrical portion 5 of the seal ring 8 as shown in FIGS. 7 and 8.

The third lip portion 11a (FIGS. 1 to 3 and FIGS. 7 to 9) or 11b (FIGS. 4 to 6) is located on the axial inner side of the bearing from the second lip portion 10, extends from the reinforcing ring 2 of the seal body 4 toward the radial direction, and is adapted to make sliding contact with the peripheral wall 7a (FIGS. 1 to 3 and FIGS. 7 to 9) or 7b (FIGS. 4 to 6) of the second cylindrical portion 7 of the seal ring 8. For example, the third lip portion 11a (FIGS. 1 to 3 and FIGS. 7 to 9) extends from the reinforcing ring 2 toward the radial direction, that is, extends toward the axial inner side (the left side in FIGS. 1 to 3 and FIGS. 7 to 9) and then extends obliquely toward the radial outer side (the upper side in FIGS. 1 to 3 and FIGS. 7 to 9), and is adapted to make sliding contact with the inner peripheral wall 7a of the second cylindrical portion of the seal ring 8. Alternatively, the third lip portion 11b (FIGS. 4 to 6) extends from the reinforcing ring 2 toward the radial direction, that is, extends toward the axial inner side (the left side in FIGS. 4 to 6) and then extends obliquely toward the radial inner side (the lower side in FIGS. 4 to 6), and is adapted to make sliding contact with the outer peripheral wall 7b of the second cylindrical portion 7 of the seal ring 8.

According to the bearing seal 1 of the present invention that has the structural features described above, one end of the seal body 4 may be fitted on and secured to the peripheral wall of the other element of the bearing rotating relative to the one element, and the first lip portion 9 and second lip portion 10 that correspond to the other end of the seal body 4 and are reinforced by the reinforcing ring 2 of the seal body 4, extending toward the seal ring 8 may be made to make sliding contact with the peripheral wall 53a of the one element of the bearing rotating relative to the other element or the peripheral wall 5a of the first cylindrical portion 5 of the seal ring 8 that is fitted on and secured to the peripheral wall 53a of the one element of the bearing rotating relative to the other element. When the bearing seal 1 of the present invention is thus mounted on the bearing that includes the one element and the other element rotating relative to each other, it can seal the bearing both internally and externally with the high reliability.

In the form as shown in FIGS. 7 to 9 in which the first cylindrical portion 5 of the seal ring 8 may be fitted on and secured to the peripheral wall of the one element of the bearing rotating relative to the other element indirectly, that is, by way of the slinger 23, the first lip portion 9 and the second lip portion 10 may be brought into sliding contact with the one peripheral surface of the cylindrical portion 21 of the slinger 23, or may be brought into sliding contact with the peripheral wall 5a of the first cylindrical portion 5 of the seal ring 8. The first cylindrical portion 5 of the seal ring 8 is fitted on and secured to the one peripheral surface of the cylindrical portion 21 of the slinger 23. Even in such case as shown in FIGS. 7 to 9, when the bearing seal 1 is mounted on the bearing including the one and other elements rotating relative to each other the bearing can be sealed both internally and externally with the high reliability.

The third lip portion 11a (FIGS. 1 to 3 and FIGS. 7 to 9) or 11b (FIGS. 4 to 6) that is provided on the elastic element 3 reinforced by the reinforcing ring 2 of the seal body 4 and is located on the axial inner side from the first lip portion 9 and second lip portion 10 are provided to extend toward the second cylindrical portion 7 extending in the axial direction from the forward end of the flange portion 6 of the seal ring 8 extending in the radial direction from the first cylindrical portion 5, and may be made to make sliding contact with the peripheral wall 7a (FIGS. 1 to 3 and FIGS. 7 to 9) or peripheral wall 7b(FIGS. 4 to 6) of the second cylindrical portion 7. Any misalignment that may occur when the bearing is mounted or any misalignment in the axial direction that may be caused by any errors in mounting the bearing can be accommodated effectively in this way.

As a first alternative form of the bearing seal that has been described so far, the first lip portion 9 and second lip portion 10 provided on the elastic element 3 reinforced by the reinforcing ring 2 may be provided to extend from the reinforcing ring 2 of the seal body 4 toward the seal ring 8, and may be made to make sliding contact with the peripheral wall 53a of the one element of the bearing rotating relative to the other element, as shown in FIGS. 2, 3, 5 and 6. As a second alternative form, the first lip portion 9 and second lip portion 10 may be provided to extend from the reinforcing ring 2 of the seal body 4 toward the seal ring 8 so that both may be made to make sliding contact with the peripheral wall 5a of the first cylindrical portion 5 of the seal ring 8 as shown in FIGS. 1 and 4. As a third alternative form, the first lip portion 9 may be provided to make sliding contact with the peripheral wall 53a of the one element of the bearing rotating relative to the other element, while the second lip portion 10 may be provided to make sliding contact with the peripheral wall 5a of the first cylindrical portion 5 of the seal ring 8, as shown in FIGS. 2 and 5.

Similarly, as one variation of the form as shown in FIGS. 7 to 9 in which the first cylindrical portion 5 of the seal ring 8 may be fitted on and secured to the peripheral wall of the one element of the bearing rotating relative to the other element indirectly, that is, by way of the slinger 23, the first lip portion 9 having the elastic element 3 reinforced by the reinforcing ring 2 and the second lip portion 10 may be provided to extend from the reinforcing ring 2 of the seal body 4 toward the cylindrical portion 21 of the slinger 23 so that both can make sliding contact with the one peripheral surface of the cylindrical portion 21 of the slinger 23, with the other peripheral surface being fitted on and secured to the peripheral wall 53a of the one element of the bearing rotating relative to the other element, as shown in FIG. 9. As another variation, the first lip portion 9 and the second lip portion 10 may be provided to extend from the reinforcing ring 2 of the seal body 4 toward the cylindrical portion 21 of the slinger 23 so that both can make sliding contact with the peripheral wall 5a of the first cylindrical portion 5 of the seal ring 8, as shown in FIG. 7. As a further variation, as shown in FIG. 8, the first lip portion 9 may be provided so that it can make sliding contact with the one peripheral surface of the cylindrical portion 21 of the slinger 23, with the other peripheral surface being fitted on and secured to the peripheral wall 53a of the one element of the bearing rotating relative to the other element, and the second lip portion 10 may be provided so that it can make sliding contact with the peripheral wall 5a of the first cylindrical portion 5 of the seal ring 8.

In any of the alternative forms described above, the bearing that includes the two elements rotating relative to each other can be sealed both internally and externally with the high reliability when the bearing seal 1 of the present invention is mounted on such bearing.

As a further alternative form of the bearing seal 1 of the present invention described so far, the second cylindrical portion 7 of the seal ring 8 may be provided to extend toward the axial outer side of the bearing, and the third lip portion 11a may be provided to extend toward the radial outer side and then extend obliquely toward the axial inner side and may be made to make sliding contact with the peripheral wall 7a on the radial inner side of the second cylindrical portion 7 of the seal ring 8.

As a still further alternative form, the second cylindrical portion 7 of the seal ring 8 may be provided to extend toward the axial outer side of the bearing, and the third lip portion 11b may be provided to extend toward the radial inner side and then extend obliquely toward the axial inner side of the bearing and may be made to make sliding contact with the peripheral wall 7b on the radial outer side of the second cylindrical portion 7 of the seal ring 8.

In any of the further alternative forms just described above, any misalignment that may occur when the bearing is mounted, or any misalignment in the axial direction that may be caused by any errors in mounting the bearing can be accommodated effectively.

In any of the embodiments of the bearing seal 1 shown in FIGS. 1 to 9 and in any of the alternative forms thereof, the reinforcing ring 2, seal ring 8 and slinger 23 may be shaped from any of the metals that are known in the relevant field. It should be noted, however, that when the bearing seal of the present invention is utilized in the water pump used with the water-cooled engine on the automotive vehicle, the reinforcing ring 2 and seal ring 8 may desirably be shaped from any metals that resist the corrosion, such as stainless steel, in order to avoid that any rust gathers on those elements. In this case, any type of metal can be used for shaping those elements without any limitation if such metal can resist the corrosion. For example, steel may be used as the base metal, which may be plated with any anticorrosive metal.

The elastic element 3 may be shaped using rubber, synthetic resin and the like that are known in the relevant field.

According to the present invention, the bearing seal may be mounted between the two elements of the bearing rotating relative to each other, such as the outer race and inner race, and can provide the sealing capabilities with the high reliability even when it is used under the hardest operating environment for an extended period of the time. Also, it can effectively accommodate any misalignment that may occur when the bearing is mounted or any misalignment in the axial direction that may be caused by any errors in mounting the bearing.

It may be appreciated from the foregoing description that the bearing seal of the present invention may be mounted between the two elements of the bearing rotating relative to each other, such as the outer race and inner race, and can provide the sealing capabilities with the high reliability even when it is used under the hardest operating environment for an extended period of the time. Accordingly, it can effectively accommodate any misalignment that may occur when the bearing is mounted or may be caused by any errors in mounting the bearing.

In the example shown in FIG. 10, a water pump bearing is provided, in which a pump shaft having an impeller connected to one end thereof and a pulley connected to the other end is rotatably mounted to the outer race of the bearing by way of a rolling element and a bearing seal is mounted on each of the opposite ends of the pump shaft mounted on the outer race for sealing the interior of the bearing, wherein, in particular, the bearing seal of the present invention is employed on the one end of the pump shaft on which the impeller is provided.

In the water pump bearing in which the bearing seal of the present invention is particularly employed on the side of the pump shaft on which the impeller is mounted, any entry of water into the bearing from the outside can be prevented effectively, and any leak of grease from the bearing can also be prevented effectively. Any misalignment that may occur when the bearing is mounted or may be caused by any errors in mounting the bearing can be accommodated by the seal portions that are created between the respective third lip portion 11a, 11b and the inner peripheral wall 7a or outer peripheral wall 7b of the second cylindrical portion 7 of the seal ring 8.

### BRIEF DESCRIPTION OF THE DRAWINGS

FIG. 1 is a cross sectional view that represents a bearing seal according to one preferred embodiment of the present invention, with some non-essential parts or elements being not shown for clarity of the illustration;

FIG. 2 is a cross sectional view that represents a bearing seal according to a variation of the embodiment shown in FIG. 1, with some non-essential parts or elements being not shown for clarity of the illustration;

FIG. 3 is a cross sectional view that represents a bearing seal according to another variation of the embodiment shown in FIG. 1, with some non-essential parts or elements being not shown for clarity of the illustration;

FIG. 4 is a cross sectional view that represents a bearing seal according to another preferred embodiment of the present invention, with some non-essential parts or elements being not shown for clarity of the illustration;

FIG. 5 is a cross sectional view that represents a bearing seal according to a variation of the embodiment shown in FIG. 4, with some non-essential parts or elements being not shown for clarity of the illustration;

FIG. 6 is a cross sectional view that represents a bearing seal according to another variation of the embodiment shown in FIG. 4, with some non-essential parts or elements being not shown for clarity of the illustration;

FIG. 7 is a cross sectional view that represents a bearing seal according to further preferred embodiment of the present invention, with some non-essential parts or elements being not shown for clarity of the illustration;

FIG. 8 is a cross sectional view that represents a bearing seal according to a variation of the embodiment shown in FIG. 7, with some non-essential parts or elements being not shown for clarity of the illustration;

FIG. 9 is a cross sectional view that represents a bearing seal according to another variation of the embodiment shown in FIG. 7, with some non-essential parts or elements being not shown for clarity of the illustration; and

FIG. 10 is a cross sectional view that illustrates the water pump bearing section in a water pump, with some non-essential parts or elements being not shown for clarity of the illustration.

### BEST MODES OF EMBODYING THE INVENTION

Several preferred embodiments of the present invention are now described in further detail by referring to the accompanying drawings.

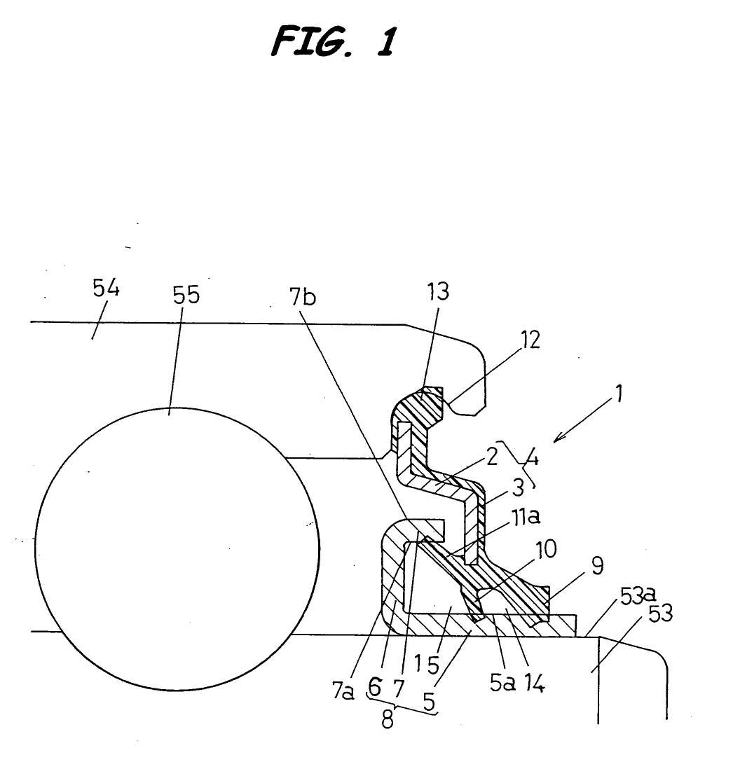

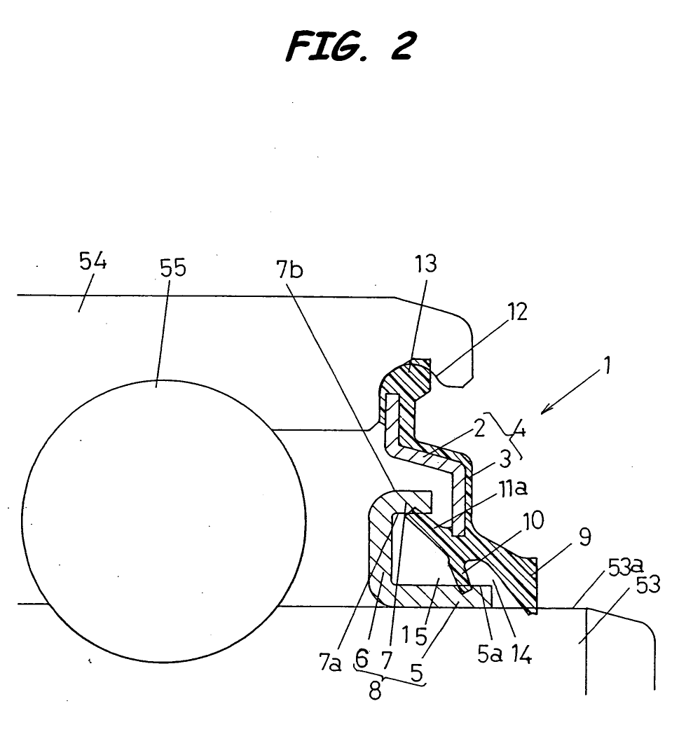

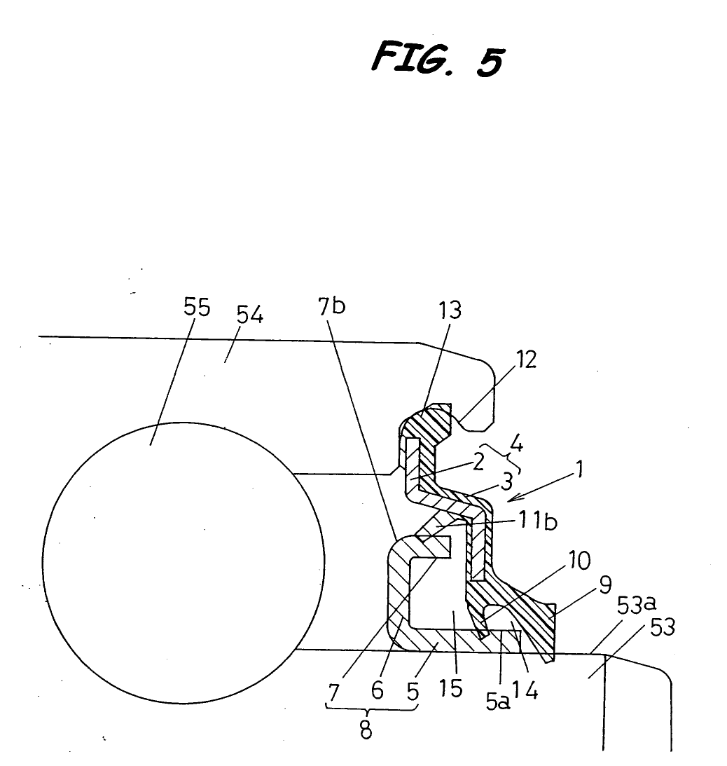

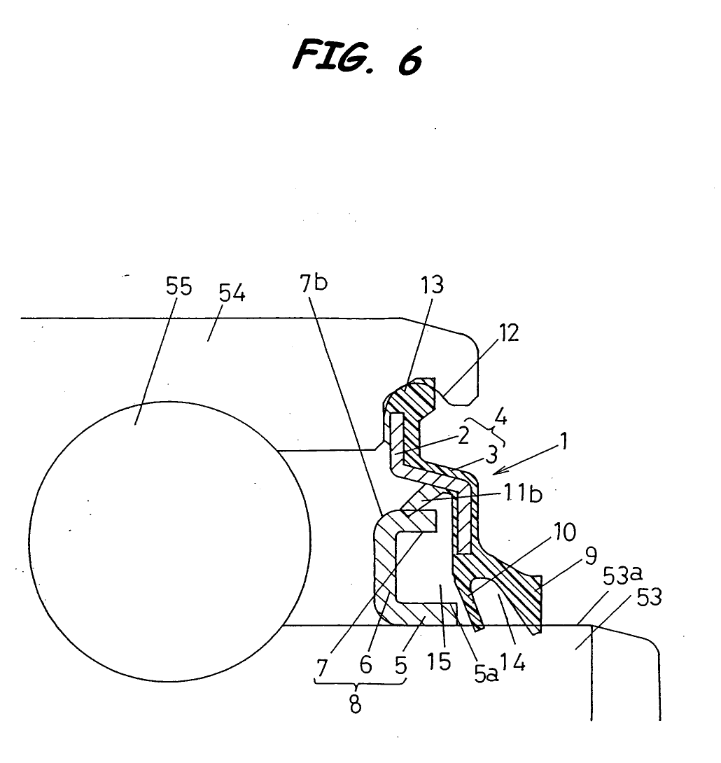

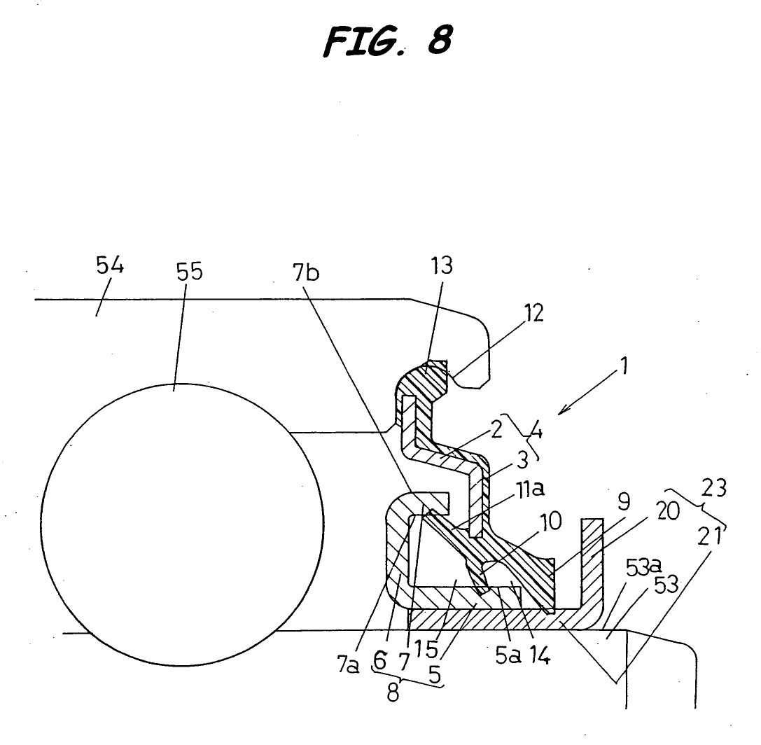

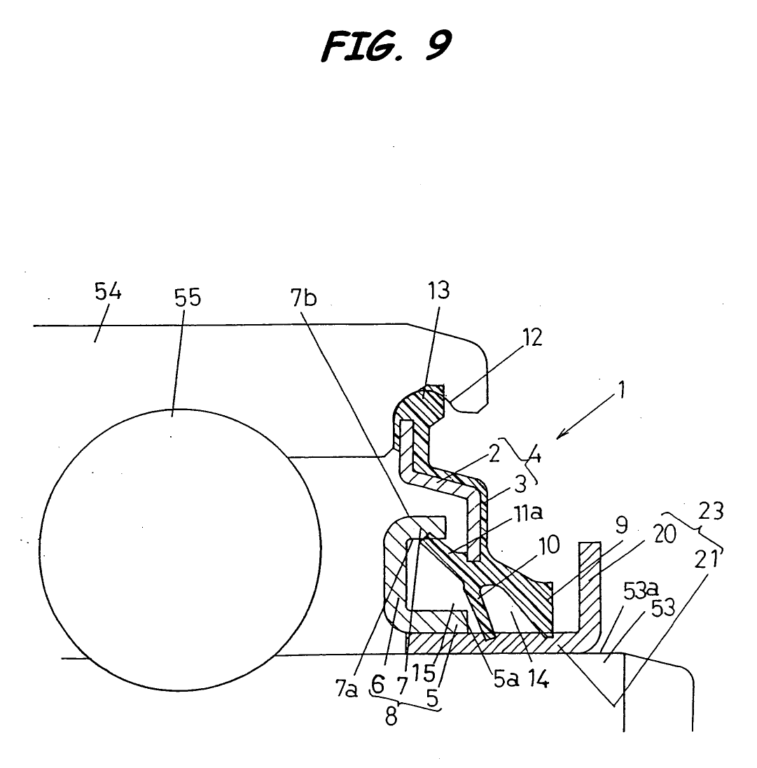

FIGS. 1 to 9 represent three different forms of a bearing seal 1 according to the present invention that are shown in cross section, although some non-essential parts or elements are not shown. It may be seen from FIGS. 1 to 9 that the bearing on which the bearing seal 1 may be mounted for sealing it is constructed to permit a pump shaft 53 rotatably to be mounted to an outer race 54 by way of a rolling element 55 and to permit the peripheral surface of the pump shaft 53 and the peripheral surface of the outer race 54 to rotate relative to each other.

As shown in FIGS. 1 to 9, the bearing seal 1 includes a seal ring 8 and a seal body 4, both of which may be fitted on and secured to one element (pump shaft 53) and the other element (outer race 54) rotating relative to each other, respectively.

The seal ring 8, which may be made of stainless steel, for example, includes a first cylindrical portion 5 extending in the axial direction of the bearing (in the horizontal direction in FIGS. 1 to 9) and adapted to be fitted on and secured to the peripheral wall 53a of the pump shaft 53 as shown in FIGS. 1 to 6, a flange portion 6 extending from the first cylindrical portion 5 toward the radial direction (in the vertical direction in FIGS. 1 to 9), and a second cylindrical portion 7 extending from the forward end of the flange portion 6 toward the axial direction of the bearing.

The seal body 4 includes a metallic reinforcing ring 2 and an elastic element 3 made of rubber and reinforced by the reinforcing ring 2.

On one end of the seal body 4 that extends in the radial, there is an end 13 of the elastic element 3 that is formed like a bump. The outer side in the radial direction located on the upper end in the examples shown in FIGS. 1 to 9 is the one end of the seal body 4. As shown in FIGS. 1 to 9, the seal ring 8 may be inserted under the applied pressure in the direction of the axial inner side (the left side in FIGS. 1 to 9), thereby permitting the first cylindrical portion 5 of the seal ring 8 to be fitted on and secured to the peripheral wall 53a of the pump shaft 53, and the seal body 4 may then be inserted under the applied pressure in the direction of the axial inner side (the left side in FIGS. 1 to 9). In this way, the end 13 of the elastic element 3 formed like the bump on the radial outer side may be made to engage a fitting groove 12 formed in the peripheral wall of the outer race 54, and the radial outer side of the seal body 14 may be fitted on and secured to the peripheral wall of the outer race 54.

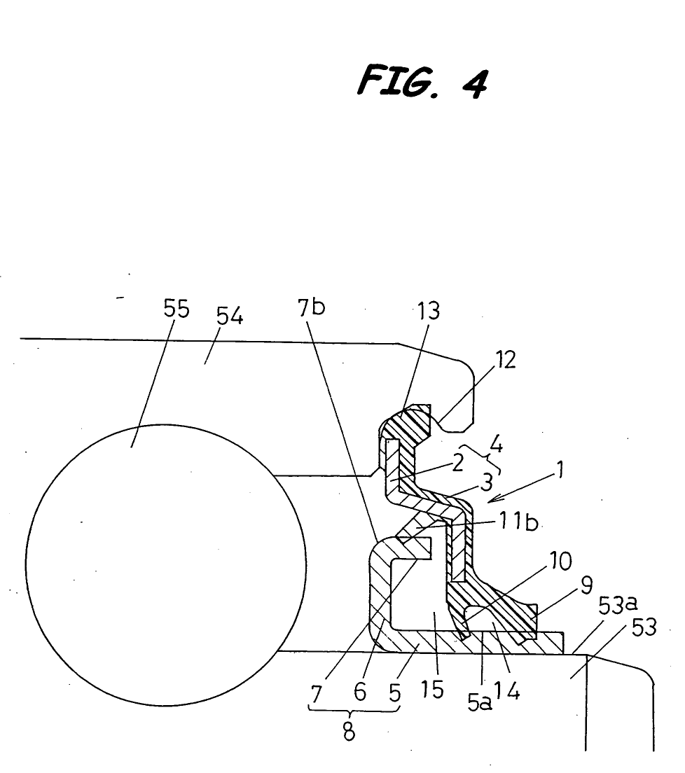

The elastic element 3 includes a first lip portion 9, a second lip portion 10 and a third lip portion 11a (FIGS. 1 to 3 and FIGS. 7 to 9), 11b (FIGS. 4 to 6).

The first lip portion 9 is provided so that it extends from the reinforcing ring 2 of the seal body 4 toward the radial inner side (toward the lower side in FIGS. 1 to 9). Specifically, in each of the embodiments shown in FIGS. 1 to 9, the first lip portion 9 extends from the reinforcing ring 2 of the seal body toward the axial outer side (toward the right side in FIGS. 1 to 9), and then extends obliquely toward the radial inner side (toward the lower side in FIGS. 1 to 9).

The second lip portion 10 is located on the inner side (the left side in FIGS. 1 to 9) in the axial direction (the horizontal direction in FIGS. 1 to 9) from the first lip portion 9, and extends from the reinforcing ring 2 of the seal body 4 toward the radial inner side (the lower side in FIGS. 1 to 9). Specifically, in each of the embodiments shown in FIGS. 1 to 9, the second lip portion 10 that is located on the axial inner side (on the left side in FIGS. 1 to 9) from the first lip portion 9 extends toward the axial outer side (toward the right side in FIGS. 1 to 9), and then extends from the reinforcing ring 2 of the seal body 4 obliquely toward the radial inner side (toward the lower side in FIGS. 1 to 9).

The third lip portion 11a (FIGS. 1 to 3 and FIGS. 7 to 9) is located on the inner side (on the left side in FIGS. 1 to 3 and FIGS. 7 to 9) in the axial direction (in the horizontal direction in FIGS. 1 to 3 and FIGS. 7 to 9) from the second lip portion 10 and extends from the reinforcing ring 2 of the seal body 4 toward the radial outer side (the upper side in FIGS. 1 to 3 and FIGS. 7 to 9), while the third lip portion 11b (FIGS. 4 to 6) is located on the inner side (on the left side in FIGS. 4 to 6) in the axial direction (in the horizontal direction in FIGS. 4 to 6) from the second lip portion 10 and extends from the reinforcing ring 2 of the seal body 4 toward the radial outer side (the lower side in FIGS. 4 to 6).

More specifically, in the embodiment shown in FIGS. 1 to 3 and FIGS. 7 to 9, the third lip portion 11a that is located on the inner side (on the left side in FIG. 1, etc) in the axial direction (in the horizontal direction in FIG. 1, etc) from the second lip portion 10 extends toward the axial inner side (the left side in FIG. 1, etc), and then extends from the reinforcing ring 2 of the seal body 4 obliquely toward the radial inner side (the lower side in FIG. 1, etc).

Similarly, in the embodiment shown in FIGS. 4 to 6, the third lip portion 11b (FIG. 4, etc) that is located on the inner side (on the left side in FIG. 4, etc) in the axial direction (in the horizontal direction in FIG. 4, etc) from the second lip portion 10 extends toward the axial inner side (the left side in FIG. 4, etc), and then extends from the reinforcing ring 2 of the seal body 4 obliquely toward the radial inner side (the upper side in FIG. 4, etc). With the seal ring 8 and seal body 4 being mounted on the bearing as shown in FIGS. 1 to 6, the radial outer side of the seal body 4 may be fitted on and secured to the peripheral wall of the outer race 54, and at the same time, in the embodiment shown in FIGS. 1 and 4, the first lip portion 9 that extends toward the axial outer side (the right side in FIGS. 1 and 4) and then extends obliquely toward the radial inner side (the lower side in FIGS. 1 and 4) may be made to make sliding contact with the peripheral wall 5a of the first cylindrical portion 5 of the seal ring 8, while the second lip portion 10 that extends toward the axial outer side (the right side in FIGS. 1 and 4) and then extends obliquely toward the radial inner side (the lower side in FIGS. 1 and 4) may be made to make sliding contact with the peripheral wall 5a of the first cylindrical portion 5 of the seal ring 8 on the axial inner side from the first lip portion 9. Further, the third lip portion 11a that extends toward the axial inner side (the left side in FIG. 1) and then extends obliquely toward the radial outer side (the upper side in FIG. 1) may be made to make sliding contact with the peripheral wall 7a of the second cylindrical portion 7 of the seal ring 8 on the axial inner side from the second lip portion 10. Similarly, in the embodiment shown in FIG. 4, the third lip portion 11b that extends toward the axial inner side (the left side in FIG. 4) and then extends obliquely toward the radial outer side (the lower side in FIG. 4) may be made to make sliding contact with the peripheral wall 7b of the second cylindrical portion 7 of the seal ring 8 on the axial inner side from the second lip portion 10.

With the bearing seal 1 of the present invention being mounted on the bearing that includes the two elements (one being the pump shaft 53 and the other being the outer race 54) rotating relative to each other as described above, the pump shaft 54 made of metal and the first cylindrical portion 5 made of stainless steel may be secured by engaging each other through the respective outer peripheral surface 53a and inner peripheral surface, both of which are made of metals, and two seal portions may also be created such that they can be spaced axially away from each other, one seal portion being created between the outer peripheral surface of the stainless steel first cylindrical portion 5 and the first lip portion 9 extending toward the axial outer side (the right side in FIGS. 1 and 4) and then extending obliquely toward the radical inner side (the lower side in FIGS. 1 and 4) and the other seal portion being created between the outer peripheral surface of the first cylindrical portion 5 and the second lip portion 10 extending toward the axial outer side (the right side in FIGS. 1 and 4) and then extending obliquely toward the radial inner side (the lower side in FIGS. 1 and 4).

In the embodiment shown in FIG. 1, a further seal portion may also be created between the inner peripheral surface 7a of the second cylindrical portion 7 made of stainless steel and the third lip portion 11a extending toward the axial inner side (the left side in FIG. 1) and then extending obliquely toward the radial outer side (the upper side in FIG. 1) so that the seal portion can be located on the axial inner side (the left side in FIG. 1) from the two seal portions mentioned above. In the embodiment shown in FIG. 4, a further seal portion may also be created between the outer peripheral surface 7b of the stainless steel second cylindrical portion 7 and the third lip portion 11b extending toward the axial inner side (the left side in FIG. 4) and then extending obliquely toward the radial inner side (the lower side in FIG. 4) so that the seal portion can be located on the axial inner side (the left side in FIG. 4) from the two seal portions mentioned above.

In either of the embodiments shown in FIGS. 1 and 4, a first sealed space 14 may thus be created among the first lip portion 9, the second lip portion 10 and the outer peripheral surface of the first cylindrical portion 5. Furthermore, in the embodiment shown in FIG. 1, a second sealed space 15 may be created among the second lip portion 10, the third lip portion 11a and the inner peripheral surface 7a of the second cylindrical portion 7 while in the embodiment shown in FIG. 4, a second seal portion 15 may be created among the second lip portion 10, the third lip portion 11a and the outer peripheral surface 7b of the second cylindrical portion 7.

Thereby, when the bearing seal 1 is installed on the bearing by mounting the seal ring 8 and seal body 14 on the two elements rotating relative to each other, according to the before described construction, any entry of water from the outside into the bearing is prevented effectively, also any leak of grease from the bearing to the outside is prevented effectively.

More specifically, any entry of water from the outside into the bearing (in the direction of the left side in FIGS. 1 and 4) that might otherwise occur can be prevented by the two seal portions that are created among the outer peripheral surface of the stainless steel first cylindrical portion 5, the first lip portion 9, and the second lip portion 10 extending toward the axial outer side (the right side in FIGS. 1 and 4) and then extending obliquely toward radial inner side (the lower side in FIGS. 1 and 4) so that the seal portions can be spaced axially away from each other, and further by the first sealed space 14 that is created by those two seal portions.

Furthermore, any leak of grease from the bearing to the outside (in the direction of the right side in FIGS. 1 and 4 that might otherwise occur can also be prevented effectively by the seal portion that is created between the inner peripheral surface 7a of the stainless steel second cylindrical portion 7 and the third lip portion 11a extending toward the axial inner side (the left side in FIG. 1) and then extending obliquely toward the radial outer side (the upper side in FIG. 1), the seal portion that is created between the outer peripheral surface 7b of the stainless steel second cylindrical portion 7 and the third lip portion 11a extending toward the axial inner side (the left side in FIG. 1) and then extending obliquely toward the radial inner side (the lower side in FIG. 1), and the second sealed space 15 that is thus created among those two seal portions, the outer peripheral surface of the stainless steel first cylindrical portion 5 and the second lip portion 10.

When the bearing seal 1 is installed on the bearing by mounting the seal ring 8 and seal body 14 on the two elements rotating relative to each other (pump shaft 53 and outer race 54) of the bearing, respectively, as shown in FIGS. 1 and 4, in the first embodiment of the present invention, the seal portion may be formed by causing the third lip portion 11a extending toward the axial inner side (the left side in FIG. 1) and then extending obliquely toward the radial outer side (the upper side in FIG. 1) to make sliding contact with the inner peripheral wall 7a of the second cylindrical portion 7 of the seal ring 8. In the second embodiment, the seal portion may be formed by causing the third lip portion 11b extending toward the axial inner side (the left side in FIG. 4) and then extending obliquely toward the radial inner side (the lower side in FIG. 4) to make sliding contact with the outer peripheral wall 7b of the second cylindrical portion 7 of the seal ring 8.

Even if there is any misalignment that may occur when the bearing is mounted or any axial misalignment that may be caused by any errors in mounting the bearing, such misalignment can effectively be accommodated by the seal portions that are created between the respective third lip portion 11a or 11b and the inner peripheral wall 7a or outer peripheral wall 7b of the second cylindrical portion 7 of the seal ring 8.

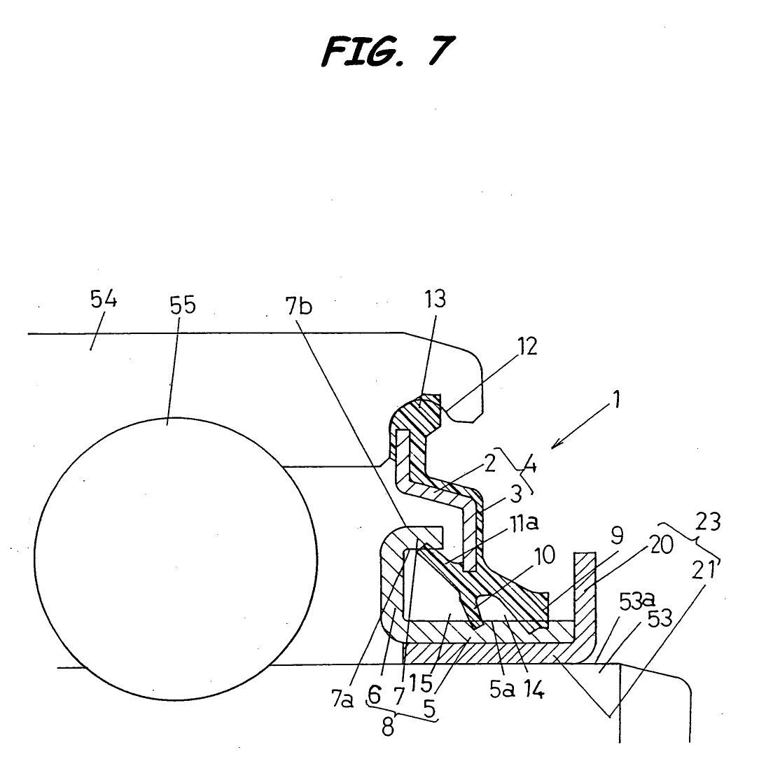

In the form shown in FIGS. 1 to 6, the first cylindrical portion 5 of the seal ring 8 may be fitted on and secured to the peripheral wall of the one element of the bearing rotating relative to the other element in the direct manner, while in the form shown in FIGS. 7 to 9, the first cylindrical portion 5 of the seal ring 8 may be fitted on and secured to the peripheral wall of the one element of the bearing rotating relative to the other element indirectly, that is, by way of the slinger 23 including the cylindrical portion 21 extending in the axial direction of the bearing and the flange portion 20 extending from the end of the cylindrical portion 21 located on the axial outer side toward the radial direction.

Except for the above, the form shown in FIGS. 7 to 9 is substantially the same as the form shown in FIGS. 1 to 3. In FIGS. 7 to 9, therefore, the parts or elements that are common to those in FIGS. 1 to 3 are given the same reference numerals, and the explanation of those parts or elements will be omitted to avoid the duplication.

The form shown in FIGS. 7 to 9 may provide the functions and effects that are explained below, in addition to those that are provided by the form shown in FIGS. 1 to 3.

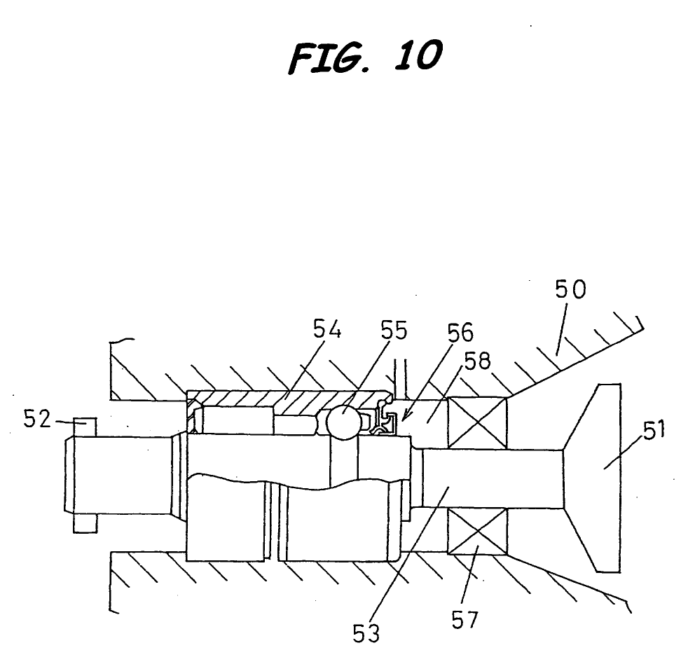

If cooling water should enter the space 58 (FIG. 10) between the pump housing 50 and pump shaft 53 where the cooling water should be heated for producing water vapor (steam), the cooling water and/or water vapor would be prevented from hitting the second lip portion 9 made of rubber or elastic element 3 directly, because of the presence of the flange 20. Furthermore, the slinger 23, which is rotating in the peripheral direction of the pump shaft 53 can expel the cooling water and/or water vapor toward the radial outer side (in the direction of an arrow 24) in the case shown in FIGS. 7 to 9, preventing the cooling water and/or water vapor from hitting the second lip portion 9 of rubber or elastic element 3. Thus, the second lip portion or elastic element 3 can have the extended lifetime.

In the form shown in FIGS. 7 to 9, the first cylindrical portion 5 of the seal ring 8 may be fitted on and secured to the peripheral wall of the one element of the bearing rotating relative to the other element by way of the slinger 23 including the cylindrical portion 21 extending in the axial direction of the bearing and the flange portion 20 extending from the end of the cylindrical portion 21 located on the radial outer side. Once the bearing seal 1 is completed by assembling its component parts, such as the seal body 4, seal ring 8 and slinger 23, it is impossible to disassemble the bearing seal into those component parts easily.

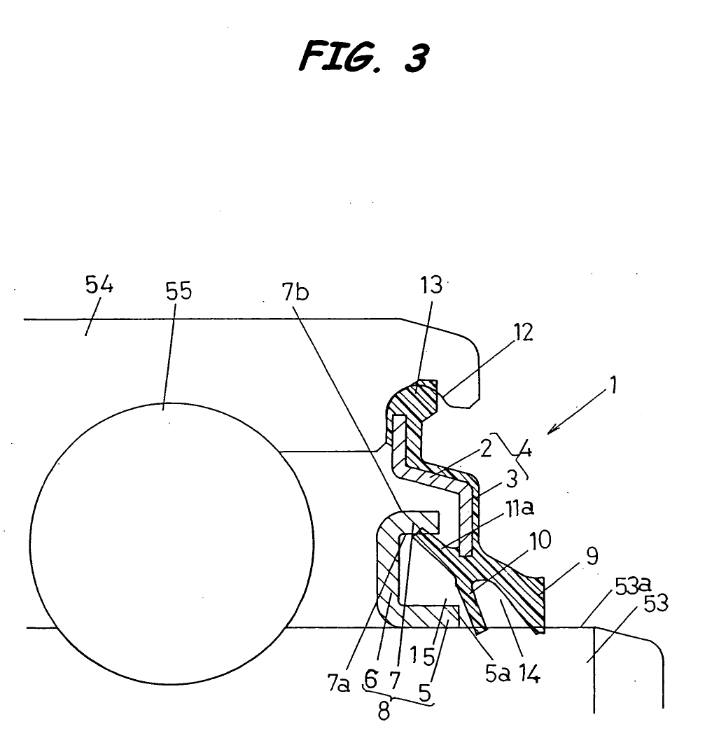

Furthermore, once the bearing seal 1 is completed by assembling its component parts, such as the seal body 4, seal ring 8 and slinger 23 as shown in FIG. 3, and is then fitted in the bearing by using any pressure tool, the contact area between the pressure tool and the bearing seal 1 can be enlarged by the presence of the slinger 23. This ensures that the bearing seal 1 is fitted in the bearing more smoothly.

Although this is not shown, the form shown in FIGS. 4 to 6 may also provide the functions and effects similar to those in the form shown in FIGS. 7 to 9, by permitting the first cylindrical portion 5 of the seal ring 8 to be fitted on and secured to the peripheral wall of the one element of the bearing rotating relative to the other element by way of the slinger including the cylindrical portion 21 extending in the axial direction of the bearing and the flange portion extending from the end of the cylindrical portion 21 located on the axial outer side toward the radial direction.

Although some preferred embodiments have been illustrated and described specifically so far, it may be appreciated that many modifications and variations of the present invention are possible in light of the above teachings and without departing from the spirit and intended scope of the invention.

What is claimed is:

1. A bearing seal including a seal ring and a seal body, the seal ring and seal body being adapted to be fitted on and secured to one element and the other element of a bearing rotating relative to each other, respectively, wherein
said seal body includes a reinforcing ring having a radial one end adapted to be fitted on and secured to the peripheral wall of said other element rotating relative to said one element of thee bearing, and an elastic element reinforced by said reinforcing ring; and
said seal ring includes a first cylindrical portion extending in the axial direction of the bearing perpendicular to the radial direction of said seal body and adapted to be fitted on and secured to the peripheral wall of said one element rotating relative to said other element of the bearing, a flange portion extending from said first cylindrical portion toward the radial direction, and a second cylindrical portion extending from the forward end side of said flange portion toward the axial direction of the bearing, wherein
upon said seal ring and said seal body being mounted in the bearing,
said elastic element includes:
a first lip portion extending from said reinforcing ring toward the other end side facing opposite said radial one end side and adapted to make sliding contact with the peripheral wall of said one element rotating relative to said other element of the bearing or the peripheral wall of said first cylindrical portion of said seal ring;
a second lip portion located on the inner side of said first lip portion in the axial direction of the bearing and extending from said reinforcing ring toward the end side facing opposite said radial one end side, and adapted to make sliding contact with the peripheral wall of said one element rotating relative to said other element of the bearing or the peripheral wall of said first cylindrical portion of said seal ring; and
a third lip portion located on the inner side of said second lip portion in the axial direction of the bearing, extending from said reinforcing ring toward the radial direction and adapted to make sliding contact with the peripheral wall of said second cylindrical portion of said seal ring.

2. A bearing seal including a seal ring and a seal body, the seal ring and seal body being adapted to be fitted on and secured to one element and the other element of a bearing rotating relative to each other, respectively, wherein
said seal body includes a reinforcing ring having a radial one end adapted to be fitted on and secured to the peripheral wall of said other element rotating relative to said one element of the bearing, and an elastic element reinforced by said reinforcing ring; and
said seal ring includes a first cylindrical portion extending in the axial direction of the bearing perpendicular to the radial direction of said seal body and adapted to be fitted on and secured to the peripheral wall of said one element rotating relative to said other element of the bearing, a flange portion extending from said first cylindrical portion toward the radial direction, and a second cylindrical portion extending from the forward end side of said flange portion toward the axial direction of the bearing, wherein
the first cylindrical portion of said seal ring is adapted to be fitted on and secured to the peripheral wall of the one element of the bearing rotating relative to the other element by way of a slinger including a cylindrical portion extending in the axial direction of the bearing and a flange portion extending from the end of said cylindrical portion of the slinger located on the axial outer side toward the radial direction, one peripheral surface of the cylindrical portion of said slinger being adapted to be fitted on and secured to the first cylindrical portion of said seal ring with the other peripheral surface being adapted to be fitted on and secured to peripheral wall of the one element of the bearing rotating relative to the other element,
upon said seal ring and said seal body being mounted in the bearing, said elastic element includes:
a first lip portion extending from said reinforcing ring toward the other end side facing opposite said radial one end side and adapted to make sliding contact with the one peripheral surface of the cylindrical portion of said slinger or the peripheral wall of said first cylindrical portion of said seal ring;
a second lip portion located on the inner side of said first lip portion in the axial direction of the bearing and extending from said reinforcing ring toward the end side facing opposite said radial one end side, and adapted to make sliding contact with the one peripheral surface of the cylindrical portion of said slinger or the peripheral wall of said first cylindrical portion of said seal ring; and
a third lip portion located on the inner side of said second lip portion in the axial direction of the bearing, extending from said reinforcing ring toward the radial direction and adapted to make sliding contact with the peripheral wall of said second cylindrical portion of said seal ring.

3. The bearing seal as defined in claim 1, wherein said second cylindrical portion of said seal ring is provide to extend toward the axial outer side of the bearing, and said third lip portion is provided to extend obliquely toward the radial outer side and toward the axial inside of the bearing and adapted to make sliding contact with the peripheral wall on the radial inner side of said second cylindrical portion of said seal ring.

4. The bearing seal as defined in claim 1, wherein said second cylindrical portion of said seal ring is provided to extend toward the axial outer side of the bearing, and said third lip portion is provided to extend obliquely toward the radial inner side and toward the axial inner side of the bearing and adapted to make sliding contact with the peripheral wall on the radial outer side of said second cylindrical portion of said seal ring.

5. The bearing seal as defined in claim 2, wherein said second cylindrical portion of said seal ring is provide to extend toward the axial outer side of the bearing, and said third lip portion is provided to extend obliquely toward the radial outer side and toward the axial inside of the bearing and adapted to make sliding contact with the peripheral wall on the radial inner side of said second cylindrical portion of said seal ring.

6. The bearing seal as defined in claim 2, wherein said second cylindrical portion of said seal ring is provided to extend toward the axial outer side of the bearing, and said third lip portion is provided to extend obliquely toward the radial inner side and toward the axial inner side of the bearing and adapted to make sliding contact with the peripheral wall on the radial outer side of said second cylindrical portion of said seal ring.
